(19) United States
(12) Patent Application Publication
(10) Pub. No.: US 2005/0273814 A1
(43) Pub. Date: Dec. 8, 2005

(54) Interactive digital television system and method of grouping data objects

(75) Inventors: Andre Heughebaert, Chaumont-Gistoux (BE); Luc De Ceulaer, Dilbeek (BE)

Correspondence Address: FROMMER LAWRENCE & HAUG LLP, 745 FIFTH AVENUE, NEW YORK, NY, 10151, US

(73) Assignee: SONY SERVICE CENTER (EUROPE) N.V.

(21) Appl. No.: 11/146,251

(22) Filed: Jun. 6, 2005

Related U.S. Application Data
(63) Continuation of application No. 09/794,895, filed on Feb. 26, 2001.

(30) Foreign Application Priority Data
Feb. 29, 2000 (EP) 00301617.7

(51) Int. Cl. H04N 5/445

(52) U.S. Cl. 725/43; 725/40

(57) ABSTRACT

An interactive digital television system and method of grouping data objects in which data objects displayed on an interactive digital television system may be grouped using the input keys of the control unit of the integrated digital television system by displaying the data objects on the display of the interactive digital television system and highlighting one of the displayed data objects, using at least one first input key of the input keys of the control unit to cause the display to move the highlighting to successive displayed data objects and using at least one second input key of the input keys of the control unit to selectively assign the currently highlighted data object to a respective group wherein, when a data object is assigned to a respective group, an image associated with the respective group is displayed with the data object.

### BACKGROUND OF THE INVENTION

1. Field of the Invention

The present invention relates to an interactive digital television system and a method of grouping data objects, in particular to grouping data objects which are displayed on the interactive digital television system using input keys on a control unit.

2. Description of the Related Art

Various functions are now available on interactive digital television systems requiring data manipulation. In particular, various data objects such as still images, may be displayed on the television screen of the system. For various reasons, it is desirable to be able to group these data objects together and then process a group as one unit. For instance, a plurality of images may be available from a camera on the system. Of these images, the user may wish to move some of them to a memory and delete others.

### OBJECTS AND SUMMARY OF THE INVENTION

Manipulation of data objects on the screen of a computer is known using a keyboard or a mouse. However, the present application recognises the need to enable grouping and manipulation of data objects using only the remote unit of the television system.

According to the present invention there is provided a method of grouping data objects displayed on an interactive digital television system using the input keys of the control unit of the integrated digital television system, the method including displaying the data objects on the display of the interactive digital television system and highlighting one of the displayed data objects, using at least one first input key of the input keys of the control unit to cause the display to move the highlighting to successive displayed data objects and using at least one second input key of the input keys of the control unit to selectively assign the currently highlighted data object to a respective group. When a data object is assigned to a respective group, an image associated with the respective group is displayed with said data object.

According to the present invention there is also provided an interactive digital television system including a display driver for displaying on a display television images and a control unit including a plurality of input keys for controlling the television system. The display driver is also for displaying on the display a plurality of data objects and applying highlighting to any one of the displayed data objects. The input keys of the control unit include at least one first input key for causing the display driver to move the highlighting to successive displayed data objects and at least one second input key for selectively assigning the currently highlighted data object to a respective group. When a data object is assigned to a respective group, the display driver causes the display to display with said data object an image associated with said respective group.

In this way, data objects displayed on the screen of the television system may be grouped together easily with only the use of two input keys. Furthermore, these input keys need not be special input keys provided specifically for the purpose of grouping data objects, but can be any of the normal input keys provided on the control unit for controlling the television system, for instance for changing channel, adjusting brightness, adjusting volume etc.

The invention is applicable to all software applications with a graphical user interface. More precisely, it may be applied, whenever a set of items is presented (displayed) to the user, and the user may select (group) a subset of these items in order to apply an action on all so grouped items.

It is even more useful if the user may want to build several groups before applying actions to each of these groups. In this case, these groups may overlap, i.e. some of the presented items may be contained in more than one group.

The merit of the invention is that the user can build several—possibly overlapping—groups of items before applying actions to the so grouped elements. In conventional systems, items may be grouped in only a single group.

In comparison with previous systems where menus or list boxes allow multiple selection of objects to a single group, the present invention allows multiple and even overlapping groups to be constructed.

By providing the associated image for grouped data objects, a user may easily consider each data object in turn by moving the highlighting from one data object to the next whilst been presented with a visual indication of how the data objects have been grouped so far.

The data objects may be highlighted in any convenient manner, for instance changing the brightness, changing the colour balance, providing a special border etc.

Preferably, the input keys of the control unit include two or more second input keys for selectively assigning the currently highlighted data object to respective groups.

In this way, each data object may be assigned to one or more groups.

Preferably, the input keys of the control unit include standard red, green, blue and yellow input keys and the red, green, blue and yellow input keys are second input keys for assigning data objects to respective groups.

These input keys provide convenient input keys which the user can easily associate with different groups.

In this case, the, images associated with the respective groups can be red, green, blue and yellow respectively corresponding to the four groups having associated red, green, blue and yellow input keys.

The image associated with a group preferably corresponds in appearance to the designation of the at least one second input key used to assign data objects to the group.

Thus, where the coloured input keys are used, the image can have a corresponding colour. Alternatively, if numeric keys are used as second input keys, then the respective images may be the corresponding numbers of the keys. Similarly, where special function input keys are used, the symbol associated with those keys on the control unit can be used as the corresponding image.

Of course the image can also make use of other features in combination with the features associating it with its group. For instance, all of the images might have the form of a marker pin. In the case of the coloured input keys, the pin could take the colour of the associated input key and, in the case of the numeric keys, the pin could include the associated number on its side. Other images are also possible, such as stars, flags etc.

Preferably, the second input keys are additionally for selectively de-assigning the currently highlighted object to the associated group.

In this way, the user merely actuates an input key to assign a data object to a group and actuates the same input key a second time to remove that data object from that group.

Preferably, the television system includes means for processing data objects, for instance moving, copying or deleting them. In this case all of the data objects assigned to a particular group may be processed together.

This allows a user to view all of the data objects together and decide which data objects should be processed in which way. It is then a simple matter to initiate the processing on a group by group basis. This is particularly advantageous when data objects may belong to several different groups and they require processing in several different ways. For a user to individually process the data groups one by one with several different processes, it may be difficult to keep track of which data objects have been processed by which process.

Preferably, when processing of data objects is to be conducted, actuation of one of said at least one second input keys will cause the processing to be conducted on all of the data objects assigned to the respective group.

Since all of the data objects are marked with the images associated with the respective groups, when a particular process is chosen, it is clear to the user which data objects will be processed by actuating the input key corresponding to the correspondingly marked data objects.

The control unit may be a remote control unit. Typically, television systems use relatively standard remote control units and it is preferable that the first and second input keys are provided in these units.

The interactive digital television system may be provided as part of an integrated, digital television or as part of a set top box. In either case, it is of particular advantage with MHEG, MHP (Multimedia Home Platform) and other standards for DVB (Digital Video Broadcast).

The present invention may be implemented in software for application to appropriate devices. It is particularly advantageous with layered program structures using an application program.

Thus, according to the present invention there may also be provided a method of grouping data objects displayed on an interactive digital television system using the input keys of the control unit of the integrated digital television system controlled by an application program running on layered programs, the method including displaying the data objects on the display of the interactive digital television system and highlighting one of the displayed data objects, using at least one first input key of the input keys of the control unit to cause the display to move the highlighting to successive displayed data objects and using at least one second input key of the input keys of the control unit to selectively assign the currently highlighted data object to a respective group. When a data object is assigned to a respective group, an image associated with said respective group is displayed with said data object.

In this way the invention may be implemented on any platform.

### BRIEF DESCRIPTION OF THE DRAWINGS

FIG. 1 illustrates a television system embodying the present invention;

FIG. 2 illustrates the display of a plurality of data objects;

FIG. 3 illustrates data objects together with associated group images;

FIG. 4 illustrates a group image;

FIGS. 5 and 6 illustrates a menu on the television screen of the system; and

FIG. 7 illustrates a layered structure in which the present invention may be embodied.

### DETAILED DESCRIPTION OF THE PREFERRED EMBODIMENTS

The invention will be more clearly understood from the following description, given by way of example only, with reference to the accompanying drawings

The present application concerns a digital television system including a television display 2 and a remote control unit 4. A processing unit 6 including a display driver and for providing television pictures and interactive services maybe formed integrally with the display 2 or, as illustrated, as a separate unit. The system may also include other components, such as a digital still camera 8.

The interactive digital television system is capable of handling many types of data files and processing and manipulating these in accordance with the commands of the user. Many of these data files will have associated representations which may appear on the television screen 2. These representations and the data with which they are associated are here described as data objects. By manipulating the data objects on the television screen 2, the files may be manipulated.

The following example considers the use of a photo gallery on the television system in which a plurality of digital pictures may be stored.

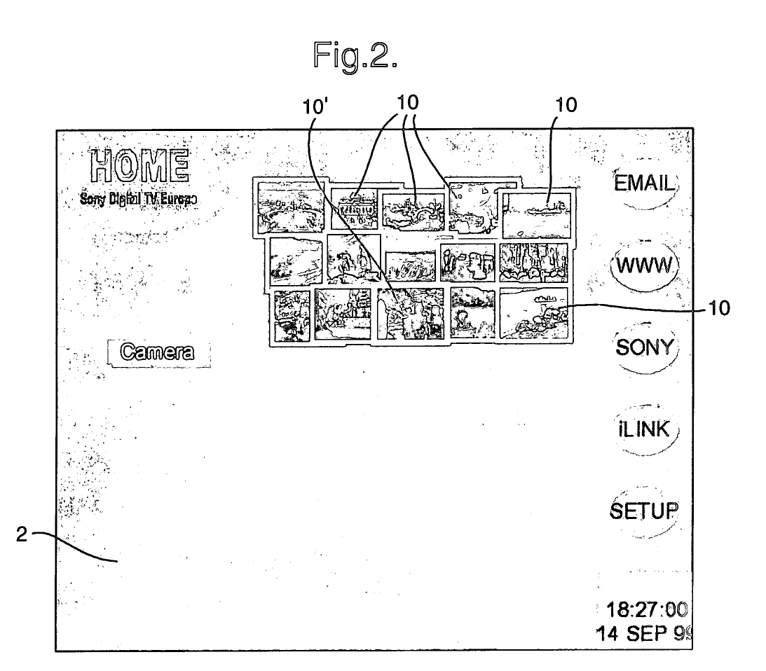

FIG. 2 illustrates display 2 showing the contents of the digital still camera 8. In particular, all of the pictures stored on the camera 8 are illustrated as data objects 10 on the screen 2.

It may be that the user wishes to select some of these pictures or data objects 10 in order to copy them into another physical storage such as a hard disc drive connected to the television system, for instance over I-link.

The remote control unit 4 has a number of input keys 12, 14, 16, 18 and 20. In the illustrated embodiment, these input keys include arrow keys 20 for moving cursors around various items on the screen and red, green, blue and yellow keys, 12, 14, 16 and 18 used for example for accessing teletext pages.

According to the present invention one of the data objects, marked 10′, of pictures 10 is highlighted on the display 2. This may be achieved in any appropriate manner. For instance, the highlighted picture may be displayed brighter than the other pictures or maybe identified by a special border.

By using one or more of the input keys 20, the system allows the user to move the highlighting to successive displayed data object pictures. In other words, each time the appropriate input key is actuated, the currently highlighted data object picture returns to normal appearance and an adjacent data object picture is highlighted. In this way, the user may successively highlight all of the data object pictures in a manner one by one.

In the illustrated embodiment, a user may assign the highlighted data object picture to a particular group by actuating one of the coloured input keys 12, 14, 16 and 18. In particular, by using the coloured input keys 12, 14, 16 and 18, the system allows assignment of data objects to four possible groups distinguished by the colours red, green, blue and yellow.

Upon actuation respectively of the red input key 12, green input key 14, blue input key 16 and yellow input key 18, the system assigns the currently highlighted data object picture to the respective red, green, blue and yellow groups.

In order for the user to keep track of the assignment of data object pictures to various groups, when a data object has been assigned to a respective group, the system causes the display to show an associated image with the data object picture. Thus, for the illustrated embodiment, when one of the coloured input keys 12, 14, 16, 18 is actuated, a corresponding coloured mark appears on the data object's picture.

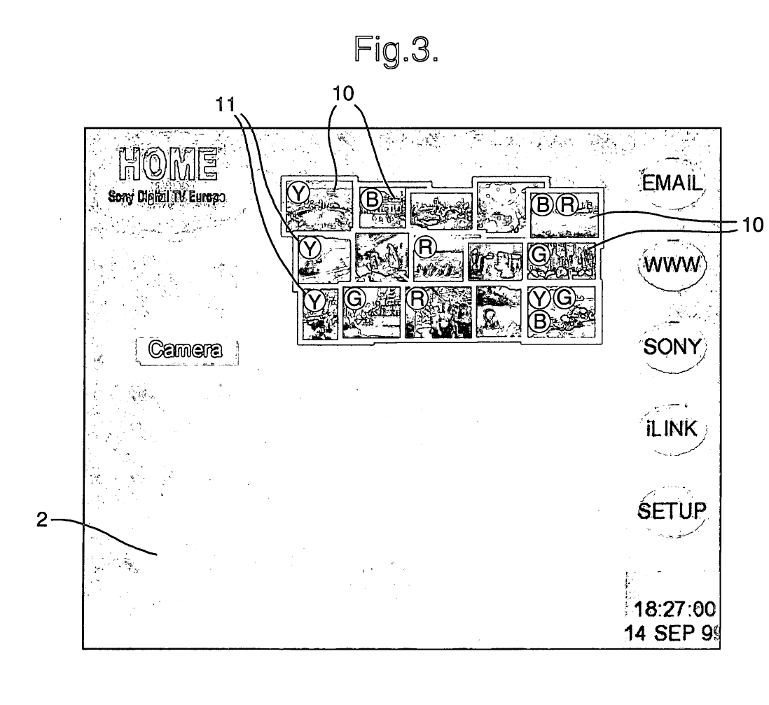

In the illustration of FIG. 3, the coloured marks are represented respectively by the letters R, G, B and Y.

By actuating the appropriate coloured input key 12, 14, 16, 18 when a data object picture is highlighted, the user can assign each data object picture to one or more of the four different groups. Thus, in the example of FIG. 3, the yellow group contains 4 pictures, the red group 3 pictures, the green group 3 pictures and the blue group 3 pictures. Furthermore, 5 pictures, including the top-middle picture, do not belong to any group.

Preferably, when a data group picture is already assigned to a particular group, by actuating the input key of that group again, the data object is removed from the group.

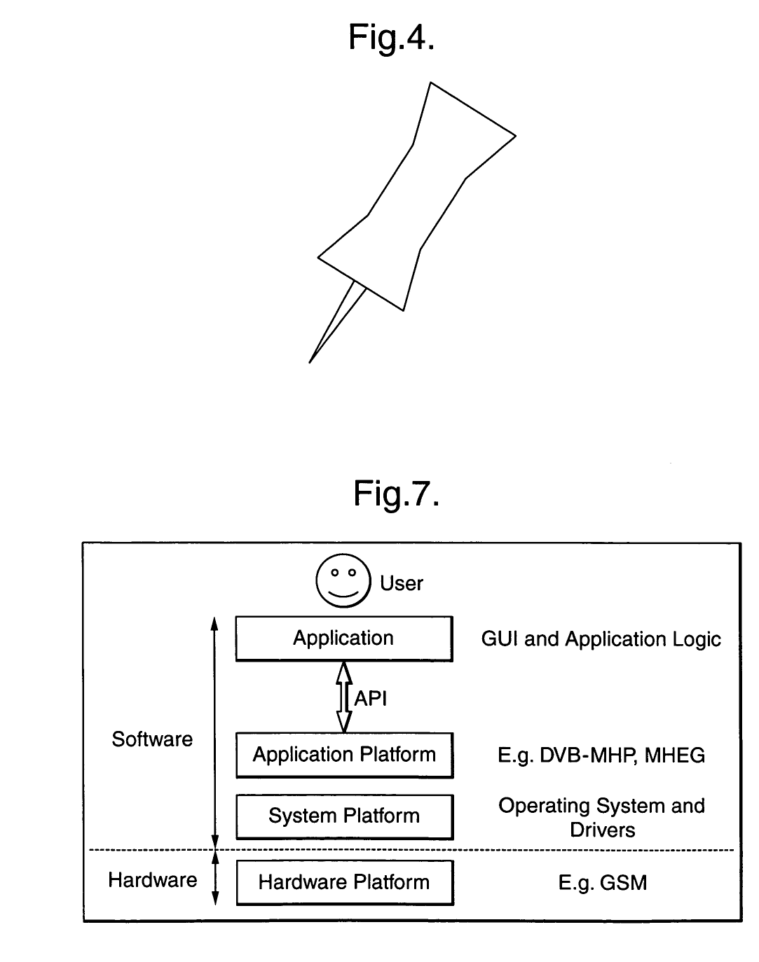

The images used with the data objects to show the group to which they have been assigned may have some decorative or meaningful appearance. Thus, as illustrated in FIG. 4, the images may take the shape of pins. These pins may be coloured according to the group colouring or include on their side a symbol representing their associated input key and group.

It should be appreciated that the groups need not only be coloured groups associated with the coloured input keys 12, 14, 16 and 18. Any other input keys of a remote control unit may be used to assign data objects to respective groups. For instance, for a remote control unit having a numerical key pad, actuation of a numeric key could cause assignment of the highlighted data object to a group having the number of the data group. The image displayed with the assigned data object then shows that number in some form.

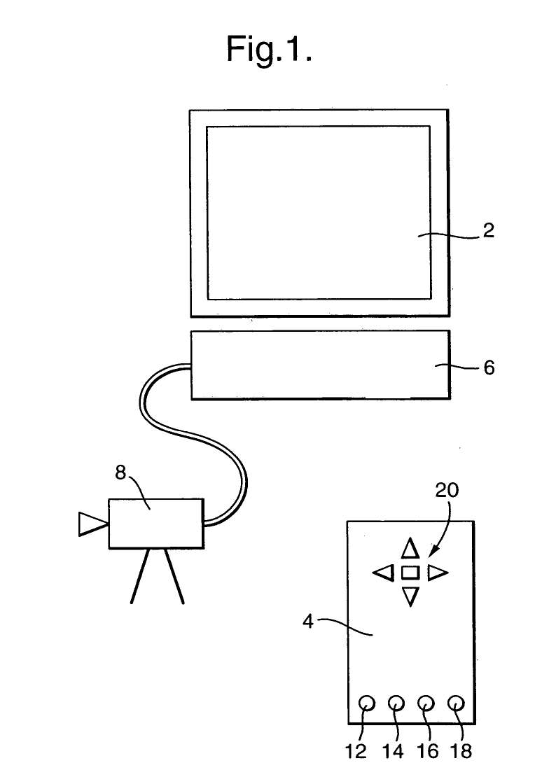

Similarly, it will be appreciated that it is not necessary to have the arrow keys 20 illustrated in FIG. 1 in order to move the highlighting. It is only necessary to have one key to move the highlighting successively through the data objects. This key can be some form of arrow or cursor key. However, any other key of the remote control unit can be assigned with this function.

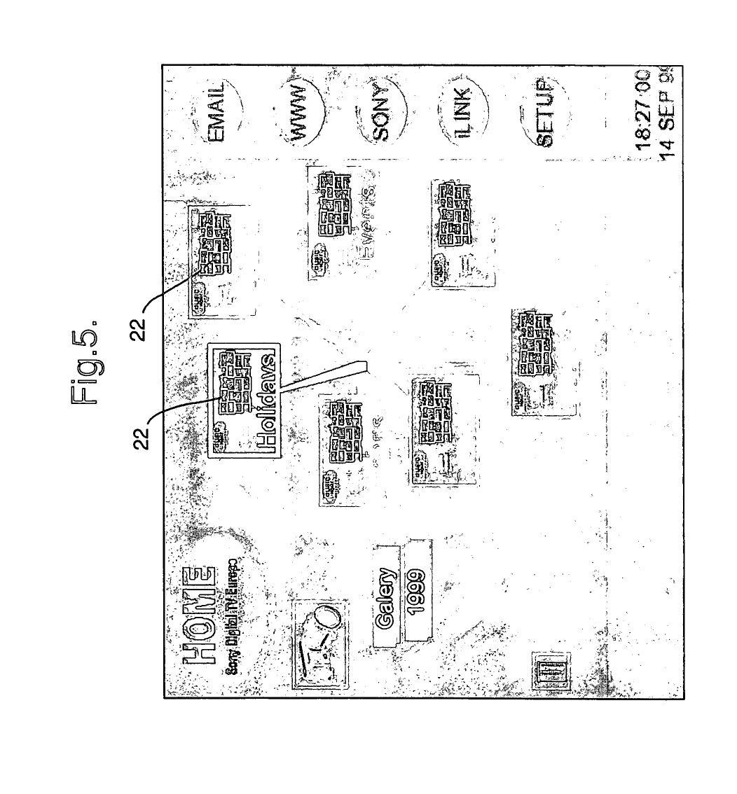

In this embodiment, the system can also display a page such as illustrated in FIG. 5. In particular, the page illustrates various folders 22 available in the picture gallery, for instance, sports, holidays, events etc.

In a similar way as described above, one of the folders is highlighted and, upon actuation of an input key, the system moves the highlighting to another folder. In FIG. 5, the “Holidays” folder is highlighted.

According to a preferred feature, with a folder highlighted, when one of the coloured input keys 12, 14, 16 and 18 is actuated, the system carries out a process on all of the data object pictures assigned to the group of the actuated input key to the highlighted folder. By way of example, in a “copy” mode, actuation of an input key will cause the corresponding group of data objects to be copied to the highlighted folder, ie the “Holiday” folder in the case of FIG. 5. Of course, with a copy function, it is still possible to copy the same data object pictures into another folder, when that other folder is highlighted. Hence, the user can copy the same group to several destination folders.

As illustrated in FIG. 6, the “Trash” symbol or folder 24 can also be highlighted. With this symbol highlighted, when one of the coloured input keys is actuated, the system removes the data object pictures of the corresponding group from their current location. Thus, in the example given, they would be removed from the camera.

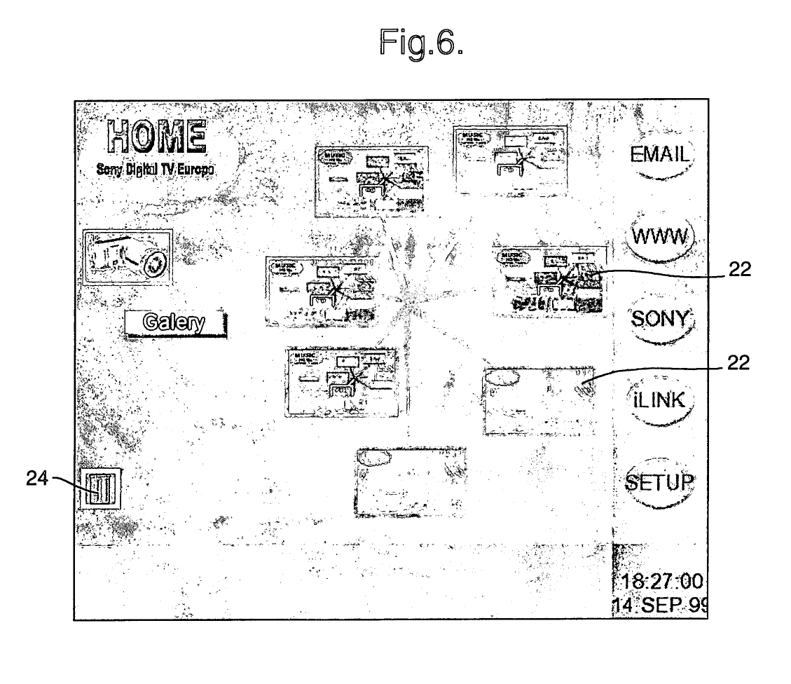

FIG. 7 shows a layered structure as it can be found in most hardware-software systems. The present invention may be implemented on this structure as discussed below.

In FIG. 7, the hardware platform consists at least of a processor and its memory, a user input device and a display device. In accordance with the description above, examples of such a hardware platform are a GSM or a digital TV set, operated by a remote control.

The system platform consists of the operating system and drivers. Amongst other things, these drivers are necessary to operate the input and display devices.

The application platform is all the software that extends the basic features of the system platform to allow an application to run on the system. In the case of a digital TV set, this may be the software stack that implements the DVB-MHP standard (Digital Video Broadcast-Multimedia Home Platform) or the MHEG standard, but it may as well be a proprietary software stack. The application platform exposes an API Application Program Interface) to be used by the application to access all the features of the system and by the application platform to notify user interaction i.e. actuation of keys to the application.

Finally, the application is composed of application logic and a GUI (graphical user interface).

The implementation of the invention is part of the application. Such an implementation relies on the API (application program interface) that is exposed by the underlying layers. This API depends on the application domain (e.g. DVB-MHP is such an API defined for digital receivers—set-top boxes). The invention can be implemented on any such platform, as long as the hardware platform contains at least a display unit and a user input device. This GUI in the application is used by the application to display to the user the different data objects, the user input focus, the selected data objects and the data objects associated with groups. In other words, by using this layered structure, the invention may be implemented on any platform and arranged according to the input keys available. It may be available in any suitable software form and loaded on to the platform as necessary.

1-28. (canceled)

29. An interactive digital hardware/software system including:
a display driver for displaying images on a display; and a control unit including a plurality of input keys for controlling the system; wherein
the display driver is also for displaying on the display a plurality of data objects and applying highlighting to any one of the displayed data objects;
the input keys of the control unit include at least one first input key for causing the display driver to move the highlighting to successive displayed data objects and at least one second input key for selectively assigning the currently highlighted data object to a respective group; and
when a data object is assigned to a respective group, the display driver causes the display to display with said data object an image associated with said respective group.

30. An interactive digital hardware/software system according to claim 29 wherein the input keys of the control unit include two or more second input keys for selectively assigning the currently highlighted data object to respective groups.

31. An interactive digital hardware/software system according to claim 30 wherein the input keys of the control unit include standard red, green, blue and yellow input keys and the red, green, blue and yellow input keys are second input keys for assigning data objects to respective groups.

32. An interactive digital hardware/software system according to claim 31 wherein the images associated with the respective groups are red, green, blue and yellow respectively corresponding to the red, green, blue and yellow input keys.

33. An interactive digital hardware/software system according to claim 30 wherein said two or more second input keys may assign individual data objects to two or more groups.

34. An interactive digital hardware/software system according to claim 29 wherein said image associated with said group corresponds in appearance to the designation of said at least one second input key used to assign data objects to said group.

35. An interactive digital hardware/software system according to claim 29 wherein said at least one second input key is additionally for selectively de-assigning the currently highlighted data object to said group.

36. An interactive digital hardware/software system according to claim 29 including means for processing data objects wherein all of the data objects assigned to a particular group may be processed together.

37. An interactive digital hardware/software system according to claim 36 wherein, when processing of data objects is to be conducted, actuation of one of said at least one second input keys will cause said processing to be conducted on all of the data objects assigned to the respective group.

38. An interactive digital hardware/software system according to claim 29 wherein the data objects comprise pictures which can at least be copied, moved and deleted from components of the interactive digital hardware/software system individually or as part of a group.

39. An interactive digital television system according to claim 29 wherein the control unit is a remote control unit.

40. An interactive digital hardware/software system according to claim 29, wherein the interactive digital hardware system is included in an integrated digital television and the display driver is for displaying television images on a display and the control unit is for controlling the integrated digital television.

41. An interactive digital hardware/software system according to claim 29, wherein the interactive digital hardware system is included in a set top box and the display driver is for displaying television images on a display and the control unit is for controlling the set top box.

42. An interactive digital hardware/software system according to claim 29 wherein the interactive digital software/hardware system is a television system which is DVB compliant.

43. An interactive digital hardware/software system according to claim 29 wherein the interactive digital software/hardware system is a television system which is MHEG and/or MHP compliant.

44. An interactive hardware/software system according to claim 29 wherein the interactive digital hardware/software system is of layered structure.

45. An interactive hardware/software system according to claim 29 wherein the interactive digital hardware/software system forms part of a camera.

46. An interactive hardware/software system according to claim 45 wherein the camera is a digital stills camera.

47. An interactive hardware/software system according to claim 29 wherein the interactive digital hardware/software system forms part of a portable telephone handset.

48. An interactive hardware/software system according to claim 47 wherein at least one of the plurality of data objects is received from an external source.

49. An interactive hardware/software system according to claim 47 wherein at least one of the plurality of data objects is generated by a user of the interactive hardware/software system.

50. A method of grouping data objects displayed on an interactive digital hardware/software system using the input keys of the control unit of the system, the method including:
displaying the data objects on the display of the system and highlighting one of the displayed data objects;
using at least one first input key of the input keys of the control unit to cause the display to move the highlighting to successive displayed data objects; and
using at least one second input key of the input keys of the control unit to selectively assign the currently highlighted data object to a respective group; wherein
when a data object is assigned to a respective group, an image associated with said respective group is displayed with said data object.

51. A method according to claim 50 wherein the interactive digital hardware/software system is a television system.

52. A method according to claim 50 using two or more second input keys for selectively assigning the currently highlighted data object to respective groups.

53. A method according to claim 52 wherein said two or more second input keys may assign individual data objects to two or more groups.

54. A method according to claim 50 wherein said image associated with said group corresponds in appearance to the designation of said at least one second input key used to assign data objects to said group.

55. A method according to claim 50 including processing all of the data objects assigned to a particular group together.

56. A method according to claim 55 wherein, when processing of data objects is to be conducted, actuation of one of said at least one second input keys will cause said processing to be conducted on all of the data objects assigned to the respective group.

57. A computer readable storage medium having recorded thereon code components that, when executed on a computer and executed will cause that computer to operate according to claim 50.

58. A computer readable storage medium having recorded thereon code components to form an application program that, when executed on a platform with layered programs and executed, will cause that platform to operate according to claim 50.

59. A method of grouping data objects displayed on an interactive digital hardware/software system of layered structure using the input keys of the control unit of the system controlled by an application program running on layered programs, the method comprising:
displaying the data objects on the display of the system and highlighting one of the displayed data objects;
using at least one first input key of the input keys of the control unit to cause the display to move the highlighting to successive displayed data objects; and
using at least one second input key of the input keys of the control unit to selectively assign the currently highlighted data object to a respective group; wherein
when a data object is assigned to a respective group, an image associated with said respective group is displayed with said data object.

60. A method according to claim 59 wherein the interactive digital hardware/software system is a television system.

61. An interactive digital device including:
a display driver for displaying images on a display; and
a control unit including a plurality of input keys for controlling the device; wherein
the display driver is also for displaying on the display a plurality of data objects and applying highlighting to any one of the displayed data objects;
the input keys of the control unit include at least one first input key for causing the display driver to move the highlighting to successive displayed data objects and at least one second input key for selectively assigning the currently highlighted data object to a respective group; and
when a data object is assigned to a respective group, the display driver causes the display to display with said data object an image associated with said respective group.
